(19) United States
(12) Patent Application Publication
(10) Pub. No.: US 2025/0222352 A1
(43) Pub. Date: Jul. 10, 2025

(54) ELECTRONIC DEVICE AND GAME EFFECT PROVIDING METHOD THEREOF

(71) Applicant: ASUSTeK COMPUTER INC., Taipei City (TW)

(72) Inventors: Yu-Hsin Wu, Taipei City (TW); Tzu-Chuan Weng Huang, Taipei City (TW); Chen-Yu Hsu, Taipei City (TW); Bo-Siang Huang, Taipei City (TW)

(73) Assignee: ASUSTeK COMPUTER INC., Taipei City (TW)

(21) Appl. No.: 18/943,808

(22) Filed: Nov. 11, 2024

(30) Foreign Application Priority Data
Jan. 10, 2024 (TW) 113101041

(51) Int. Cl. A63F 13/52; A63F 13/28; A63F 13/53

(52) U.S. Cl. CPC A63F 13/52; A63F 13/28; A63F 13/53

(57) ABSTRACT

An electronic device and a game effect providing method are provided. The method is suitable for the electronic device including an effect providing device and includes the following steps. A game application is executed, and a game frame of the game application is captured. Frame content of the game frame is recognized to obtain game status information. The game status information is compared with at least one threshold value. Based on a comparison result of the game status information and the at least one threshold value, the effect providing device is controlled to provide a tactile effect or a visual effect.

### CROSS-REFERENCE TO RELATED APPLICATION

This application claims the priority benefit of Taiwan application serial no. 113101041, filed on Jan. 10, 2024. The entirety of the above-mentioned patent application is hereby incorporated by reference herein and made a part of this specification.

### BACKGROUND

### Technical Field

The disclosure relates to an electronic device and a game effect providing method.

### Description of Related Art

With the advancement of technology, powerful performance and rich applications have made electronic devices an indispensable item for modern people's daily lives. For example, playing games on the electronic devices has become a very popular pastime. As the performance of the electronic devices improves day by day, the gameplay and types of the games are also becoming increasingly rich. Currently, in a field of game development, in order to enhance fun and richness of the games, game developers have designed different visual effects and integrated the effects into a game frame. However, relying solely on the visual effects provided by the game frame itself may have certain limitations and may not fully satisfy gaming experiences of players.

### SUMMARY

The disclosure provides a game effect providing method suitable for an electronic device including an effect providing device. The method includes the following steps. A game application is executed, and a game frame of the game application is captured. Frame content of the game frame is recognized to obtain game status information. The game status information is compared with at least one threshold value. The effect providing device is controlled to provide a tactile effect or a visual effect based on a comparison result of the game status information and the at least one threshold value.

The disclosure further provides an electronic device, including an effect providing device, a storage device, and a processor. The storage device records multiple modules. A processor is coupled to the storage device and executes the modules to execute the following steps. A game application is executed, and a game frame of the game application is captured. Frame content of the game frame is recognized to obtain game status information. The game status information is compared with at least one threshold value. The effect providing device is controlled to provide a tactile effect or a visual effect based on a comparison result of the game status information and the at least one threshold value.

Based on the above, in the embodiments of the disclosure, when the game application is executed, the frame content of the captured game frame may be recognized to obtain the game status information. The effect providing device of the electronic device may provide the tactile effect or/and the visual effect based on the comparison result of the game status information and the threshold value. On this basis, the electronic device may release the tactile effect or the visual effect of different levels according to a game status and operations of the user, allowing the user to obtain a better game experience.

In order for the aforementioned features and advantages of the disclosure to be more comprehensible, embodiments accompanied with drawings are described in detail below.

### BRIEF DESCRIPTION OF THE DRAWINGS

FIG. 1 is a schematic view of an electronic device according to an embodiment of the disclosure.

FIGS. 2A and 2B are schematic views of an effect providing device according to an embodiment of the disclosure.

FIG. 3 is a flow chart of a game effect providing method according to an embodiment of the disclosure.

FIG. 4 is a flow chart of obtaining game status information according to an embodiment of the disclosure.

FIG. 5 is a schematic view of an operation of obtaining game status information according to an embodiment of the disclosure.

FIG. 6 is a flow chart of a game effect providing method according to an embodiment of the disclosure.

FIG. 7 is a schematic view of a situation of a game effect providing method according to an embodiment of the disclosure.

### DETAILED DESCRIPTION OF DISCLOSED EMBODIMENTS

Reference will now be made in detail to the exemplary embodiments of the disclosure, and examples of the exemplary embodiments are illustrated in the accompanying drawings. Whenever possible, the same reference numerals are used in the drawings and descriptions to indicate the same or similar parts. The embodiments are only a part of the disclosure and do not disclose all possible implementations of the disclosure. More precisely, the embodiments are merely examples of the device and the method.

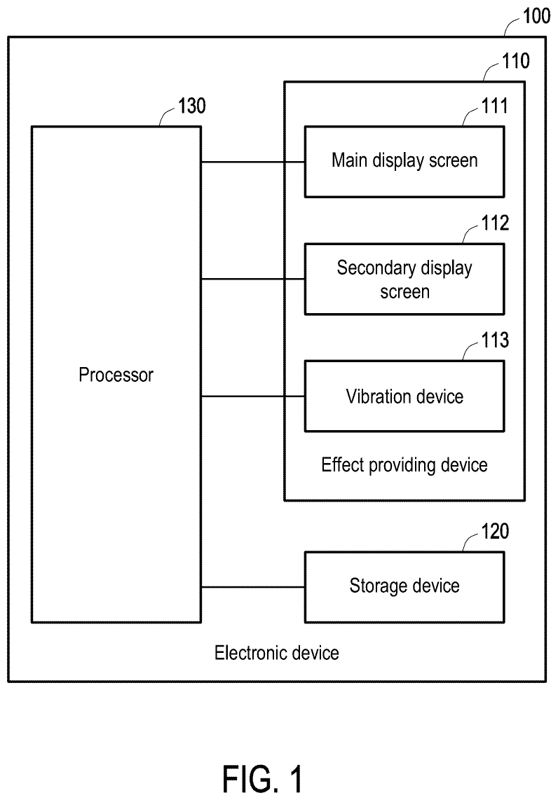

Referring to FIG. 1, an electronic device 100 in this embodiment is, for example, an electronic device, such as a smartphone, a tablet computer, a notebook computer that may execute game applications. The disclosure is not limited thereto. The electronic device 100 includes an effect providing device 110, a storage device 120, and a processor 130, and functions thereof are described as follows.

The effect providing device 110 is configured to provide a tactile effect or a visual effect to a user. In some embodiments, the effect providing device 110 may include a main display screen 111, a secondary display screen 112, and a vibration device 113. The main display screen 111 and the secondary display screen 112 may provide the visual effect. The vibration device 113 may provide the tactile effect.

The main display screen 111 and the secondary display screen 112 are, for example, liquid crystal displays (LCDs), light-emitting diode (LED) displays, field emission displays (FEDs), organic light-emitting diode (OLED) displays, or other types of displays. The disclosure is not limited thereto.

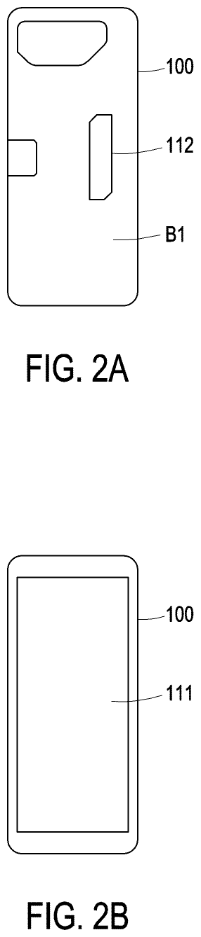

Referring to FIGS. 2A and 2B, in some embodiments, the main display screen 111 and the secondary display screen 112 are located on a front side and a back side of the electronic device 100 respectively. However, relative positions of the main display screen 111 and the secondary display screen 112 may not be limited thereto. In some embodiments, the secondary display screen 112 may be disposed in a groove or an opening of a back cover B1 of the electronic device 100. Therefore, when the user plays a game while watching the main display screen 111 of the electronic device 100, the visual effect provided by the secondary display screen 112 may be felt by other people around the user, thereby enhancing a game atmosphere.

The vibration device 113 may be a motor vibration device, a piezoelectric vibration device, or a linear resonator vibration device, and the disclosure is not limited thereto.

The storage device 120 is configured to store data such as files, images, instructions, program codes, software modules, which may be, for example, any type of fixed or removable random access memory (RAM), read-only memory (ROM), flash memory, hard disk or other similar devices, integrated circuits, or a combination thereof.

The processor 130 is, for example, a central processing unit (CPU), an application processor (AP), other programmable general-purpose or special-purpose microprocessors, a digital signal processor (DSP), a programmable controller, an application specific integrated circuit (ASIC), a programmable logic device (PLD), a graphics processing unit (GPU) or other similar devices, or a combination of the devices. The processor 130 may execute the program codes, software modules, instructions, etc. recorded in the storage device 120 to implement a game effect providing method in this embodiment. The above software modules may be broadly interpreted to mean instructions, instruction sets, codes, program codes, programs, applications, software packages, threads, procedures, functions, etc.

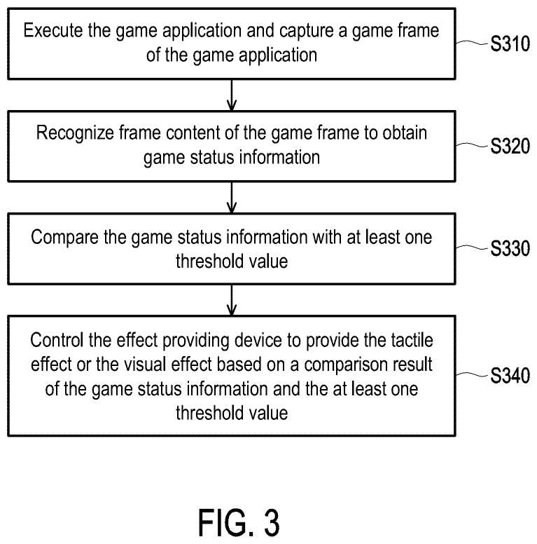

FIG. 3 is a flow chart of a game effect providing method according to an embodiment of the disclosure. Referring to FIGS. 1 and 3, the method in this embodiment is applicable to the electronic device 100 in the above embodiment. The following is a description of detailed steps in the game effect providing method in this embodiment using various elements in the electronic device 100.

In step S310, the processor 130 executes the game application and captures a game frame of the game application. In detail, when the game application is executed, the main display screen 111 displays the game frame of the game application. In some embodiments, the processor 130 may capture a window frame of the game application to obtain the game frame. In some embodiments, the processor 130 may capture a screen frame of the main display screen 111 to obtain the game frame.

In some embodiments, the processor 130 may periodically capture the game frame of the game application. For example, the processor 130 may capture one game frame every 1 second.

In step S320, the processor 130 recognizes frame content of the game frame to obtain game status information. The processor 130 may recognize the frame content of the game frame by using recognition technologies such as text recognition, image object recognition, or color recognition. In other words, the processor 130 may recognize text, values, patterns, image objects, or scene colors, etc. in the game frame. Afterwards, the processor 130 may obtain the game status information based on a recognition result. In some embodiments, the processor 130 may recognize the frame content of the game frame by using a convolutional neural network model or other machine learning models.

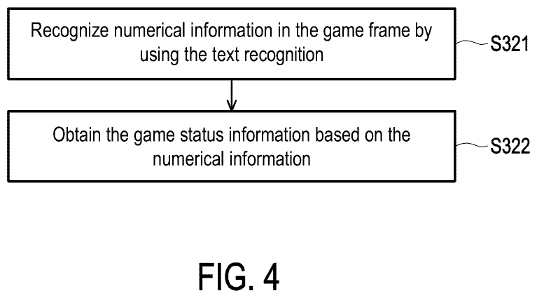

Referring to FIG. 4, FIG. 4 is a flow chart of obtaining game status information according to an embodiment of the disclosure. In some embodiments, step S320 may be implemented as step S321 to step S322.

In step S321, the processor 130 recognizes numerical information in the game frame by using the text recognition. Specifically, the processor 130 may perform the text recognition on a preset area in the game frame to obtain the numerical information in the game frame. For example, the above numerical information may be the number of kills, health points, game time, game scores, or other values related to game content.

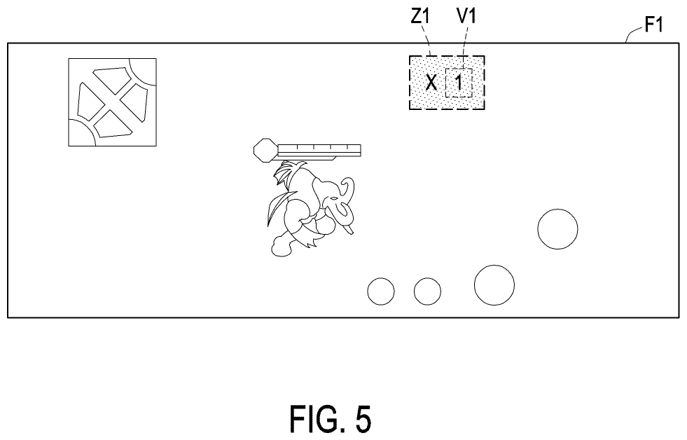

Referring to FIG. 5, after capturing a game frame F1, the processor 130 may perform the text recognition on a preset area Z1 in the game frame F1. The processor 130 may recognize numerical information V1 from the preset area Z1 in the game frame F1, which is the number of kills that a target object is successfully killed. In this example, the number of kills (i.e., the numerical information V1) in the game frame F1 is 1, for example. In the disclosure, a size and a position of the preset area are not limited. The size and the position of the preset area may be determined by a configuration of a game operation interface.

In step S322, the processor 130 obtains the game status information based on the numerical information. In some embodiments, the processor 130 may perform statistical operation processing on the numerical information in multiple game frames to obtain the game status information. The above statistical processing is, for example, accumulation processing, decrement processing, average processing, or other statistical operation processing. In some embodiments, the processor 130 may use the numerical information in each of the game frames as the game status information. As a result, a game operation method of the user will determine the game status information.

In some embodiments, the numerical information in the game frame is the number of occurrences of an event for a game event. The game event is, for example, a kill event or other game events. Then, the processor 130 may calculate the cumulative number of events within a statistical period based on the number of occurrences of the event. That is, the game status information may be the cumulative number of events. In the disclosure, a length of the statistical period is not limited, which may be set according to actual applications. For example, the processor 130 may calculate the cumulative number of events every 3 minutes. In addition, the processor 130 may calculate the cumulative number of events during an entire game execution period.

In some embodiments, the game event includes the kill event, and the number of occurrences of the events includes the number of kills. Taking FIG. 5 as an example, assuming that the game application will display the number of kills of the kill event in real time, the processor 130 may recognize the number of kills of the kill event from the game frame F1. Afterwards, the processor 130 may accumulate the number of kills on the game frame F1 and the number of kills on other game frames to obtain the cumulative number of kills within the statistical period. In other words, the game status information may include the cumulative number of kills.

In addition, in some embodiments, assuming that the game application displays the game elapsed time in real time, the processor 130 may recognize the game time from the game frame F1. Afterwards, the processor 130 may calculate the remaining game time based on the game time and the game limit time. In other words, the game status information may include the remaining game time.

In addition, in some embodiments, assuming that the game application displays health points of a game character in real time, the processor 130 may recognize the health points from the game frame F1. When the health points of the game character reaches zero, the game application will end the game. The processor 130 converts the health points to one of several end-game risk values. The end-game risk value may include a low risk value, a medium risk value, a high risk value, etc. In other words, the game status information may include the end-game risk values.

Returning to FIG. 3, in step S330, the processor 130 compares the game status information with at least one threshold value. An actual value of the above threshold value may be set according to the actual applications, and the disclosure is not limited thereto. In addition, in different embodiments, the number of at least one threshold value may be 1, 2, 3, or other numbers. In other words, the processor 130 may also determine that the game status information falls into one of numerical ranges formed by multiple threshold values.

In step S340, the processor 130 controls the effect providing device 110 to provide the tactile effect or the visual effect based on a comparison result of the game status information and the at least one threshold value. Specifically, the processor 130 may determine a level of the effect based on the comparison result of the game status information and the threshold value. In some embodiments, when the game status information is less than or equal to a first threshold value, the processor 130 controls the effect providing device 110 to provide a first tactile effect or a first visual effect. When the game status information is greater than the first threshold value, the processor 130 controls the effect providing device 110 to provide a second tactile effect or a second visual effect.

Therefore, when the processor 130 detects that a specific game situation occurs, the processor 130 may control the effect providing device 110 to provide the tactile effect or the visual effect according to the currently determined level of the effect. The above specific game situation is, for example, release of game stunts, occurrences of the kill event, or other game situations, and the disclosure is not limited thereto.

In some embodiments, the visual effect includes a main visual effect displayed on the main display screen 111. Based on the comparison result of the game status information and the at least one threshold value, the processor 130 may determine a visual feature of the main visual effect. The above visual feature may include colors, shapes, transparency, pattern sizes, or other visual features. Then, the processor 130 may control the main display screen 111 to display the main visual effect at an edge of a program frame of the game application according to the visual feature of the main visual effect. The main visual effect may be superimposed on the program frame of the game application for display. That is to say, the processor 130 may perform image synthesis processing or image superposition processing on the game frame and the main visual effect provided by the game application, and display the game frame superimposed with the main visual effect on the main display screen 111. In addition, if the main visual effect is presented at the edge of the program frame of the game application, it may prevent the main visual effect from blocking the game content, and may be applied to various game applications.

In some embodiments, the visual effect includes a secondary visual effect displayed on the secondary display screen 112. Based on the comparison result of the game status information and the at least one threshold value, the processor 130 may determine a visual feature of the secondary visual effect. The secondary visual effect includes icons, text, logos, or symbols of the game application. The secondary visual effect may include an animated image or a static image. The above visual feature may include colors, pattern shapes, pattern sizes, text content, image content, or other visual features. Then, the processor 130 may control the secondary display screen 112 to display the secondary visual effect according to the visual feature of the secondary visual effect. In some embodiments, as shown in FIGS. 2A and 2B, the secondary display screen 112 faces away from the main display screen 111.

In some embodiments, the tactile effect includes a vibration effect provided by the vibration device 113. The processor 130 may determine a vibration amplitude based on the comparison result of the game status information and the at least one threshold value. Then, the processor 130 may control the vibration device 113 to provide the vibration effect according to the vibration amplitude. In other words, the vibration device 113 may provide the vibration effect with different vibration amplitudes based on the comparison result of the game status information and the at least one threshold value.

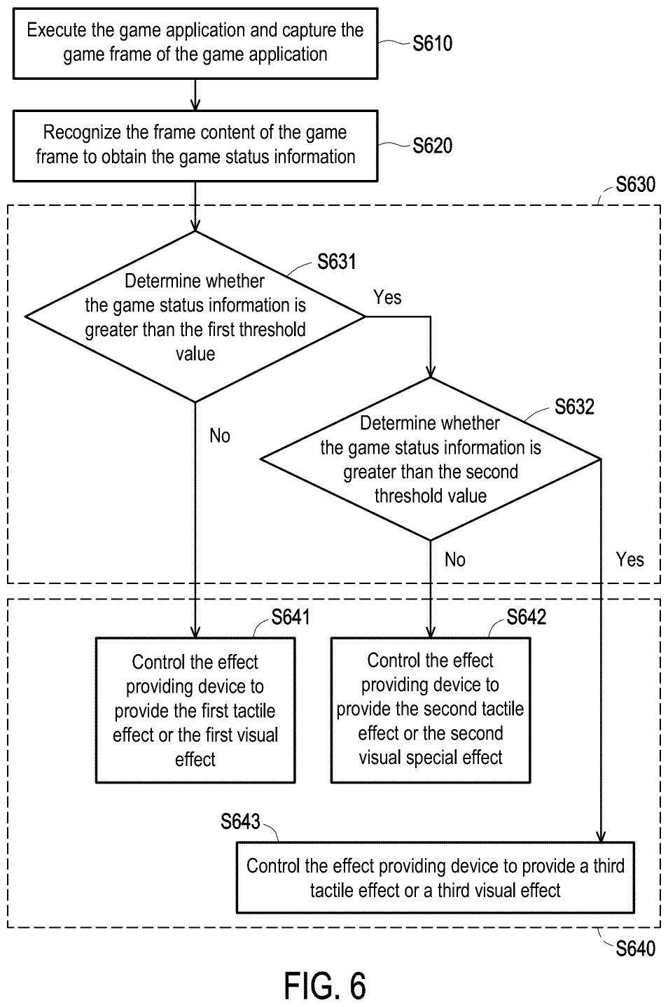

In order to describe more clearly that the electronic device 100 may determine the level of the effect based on the comparison result of the game status information and the threshold value, the embodiments will be described in the following. Referring to FIGS. 1 and 6, the method shown in FIG. 6 is applicable to the electronic device 100 in the above embodiment. The following is a description of detailed steps in the game effect providing method in this embodiment using various elements in the electronic device 100.

In step S610, the processor 130 executes the game application and captures the game frame of the game application. In step S620, the processor 130 recognizes the frame content of the game frame to obtain the game status information. The previous descriptions may be referred for detailed implementations of the steps. Therefore, the same details will not be repeated in the following.

In step S630, the processor 130 compares the game status information with the at least one threshold value. In some embodiments, the threshold value may include the first threshold value and a second threshold value. The second threshold value is greater than the first threshold value. In other words, the processor 130 may determine the level of the effect based on a comparison result between the game status information and the first threshold value and the second threshold value. In other words, with increasing of the time the user continues to operate the game application and in different operation methods, the game status information dynamically changes. Correspondingly, the processor 130 may also control the effect providing device 110 to provide the visual effect or tactile effect of different levels of the effect.

In some embodiments, step S630 may be implemented as step S631 to step S632. In step S631, the processor 130 determines whether the game status information is greater than the first threshold value. If the determination in step S631 is yes, in step S632, the processor 130 determines whether the game status information is greater than the second threshold value. In this way, the processor 130 may divide the game status information into one of three numerical ranges. Specifically, if the determination in step S631 is no, it means that the game status information is less than or equal to the first threshold value, that is, it is within a first value range. If the determination in step S632 is no, it means that the game status information is greater than the first threshold value and less than or equal to the second threshold value, that is, it is within a second value range. If the determination in step S632 is yes, it means that the game status information is greater than the second threshold value, that is, it is in a third value range. According to the numerical range where the game status information is located, the processor 130 may determine the corresponding level of the effect.

In step S640, the processor 130 controls the effect providing device 110 to provide the tactile effect or the visual effect based on the comparison result of the game status information and the at least one threshold value. In some embodiments, step S640 may be implemented as step S641 to step S643. If the determination in step S631 is no, when the game status information is less than or equal to the first threshold value, the processor 130 controls the effect providing device 110 to provide the first tactile effect or the first visual effect. If the determination in step S632 is no, when the game status information is greater than the first threshold value and less than or equal to the second threshold value, the processor 130 controls the effect providing device 110 to provide the second tactile effect or the second visual special effect. If the determination in step S632 is yes, when the game status information is greater than the second threshold value, the processor 130 controls the effect providing device 110 to provide a third tactile effect or a third visual effect.

It should be noted that the first visual effect, the second visual effect, and the third visual effect corresponding to different levels of the effect may respectively correspond to different visual features. For example, the first visual effect of a first level of the effect is green, the second visual effect of a second level of the effect is blue, and the third visual effect of a third level of the effect is red. In addition, for example, the first visual effect, the second visual effect, and the third visual effect corresponding to different levels of the effect may respectively correspond to different text content or different patterns.

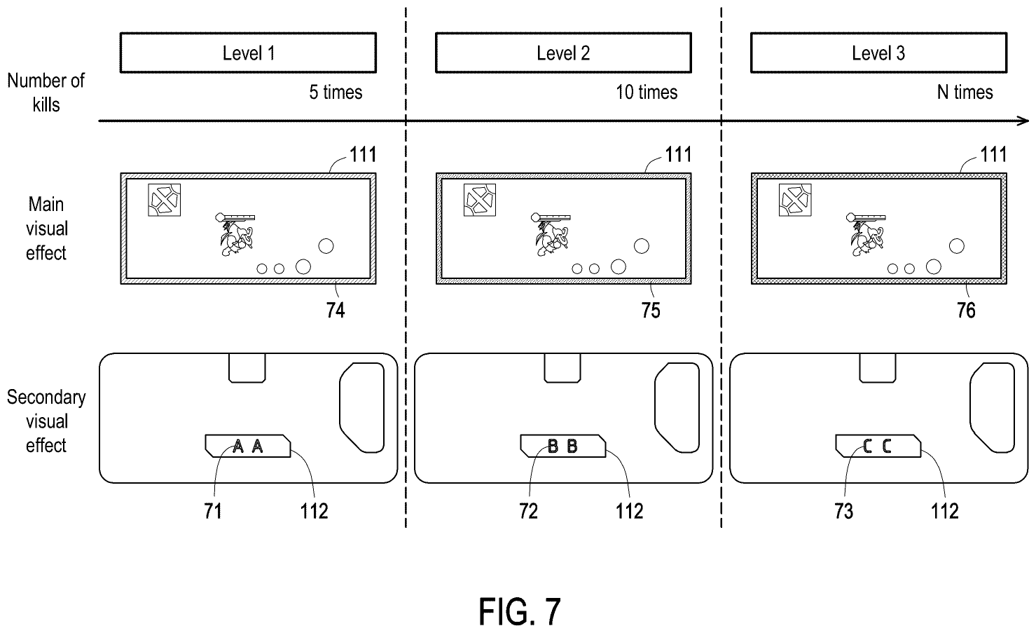

FIG. 7 is a schematic view of a situation of a game effect providing method according to an embodiment of the disclosure. Referring to FIG. 7, when the electronic device 100 executes the game application, the processor 130 may periodically capture the game frames and perform the text recognition on the game frames to obtain the number of kills in the game frame. After the game starts, the processor 130 may accumulate the number of kills in the first game frame to the number of kills in the n-th game frame (e.g., the current game frame) to obtain the cumulative number of kills.

At the beginning of the game, when the cumulative number of kills is less than or equal to 5, the processor 130 determines that the effect providing device 110 provides the first visual effect and the first tactile effect of the first level of the effect. In this example, the main display screen 111 may display a main visual effect 74 at the edge of the program frame. The main visual effect 74 may be an outer frame of a first color. Furthermore, the secondary display screen 112 may display a secondary visual effect 71. The secondary visual effect 71 may be text content “AA” of the first color. In addition, the vibration device 113 may provide the vibration effect with a light vibration amplitude.

In the middle of the game, when the cumulative number of kills is greater than 5 times and less than or equal to 10 times, the processor 130 determines that the effect providing device 110 provides the second visual effect and the second tactile effect of the second level of the effect. In this example, the main display screen 111 may display a main visual effect 75 at the edge of the program frame. The main visual effect 75 may be an outer frame of a second color. Furthermore, the secondary display screen 112 may display a secondary visual effect 72. The secondary visual effect 72 may be text content “BB” of the second color. In addition, the vibration device 113 may provide the vibration special effect with a medium vibration amplitude.

In the late stage of the game, when the cumulative number of kills is greater than 10 times, the processor 130 determines that the effect providing device 110 provides the third visual effect and the third tactile effect of the third level of the effect. In this example, the main display screen 111 may display a main visual effect 76 at the edge of the program frame. The main visual effect 76 may be an outer frame of a third color. Furthermore, the secondary display screen 112 may display a secondary visual effect 73. The secondary visual effect 73 may be text content “CC” of the third color. In addition, the vibration device 113 may provide the vibration effect with a strong vibration amplitude. On this basis, since in the embodiments of the disclosure, game effects of different levels may be provided along with a game process and in response to game results, players may be more immersed in a game experience.

Based on the above, in the embodiments of the disclosure, the effect providing device of the electronic device may provide the tactile effect or/and the visual effect based on the comparison result of the game status information and the threshold value. On this basis, the electronic device may release the tactile effect or the visual effect of different levels according to a game status and operations of the user, allowing the user to obtain a better game experience and greatly enhance fun of the game. In addition, the game effect is provided through the display screens and the vibration device, allowing the user and people around the user to feel a stronger game atmosphere and interactive feedback.

Lastly, it is to be noted that: the embodiments described above are only used to illustrate the technical solutions of the disclosure, and not to limit the disclosure; although the disclosure is described in detail with reference to the embodiments, those skilled in the art should understand: it is still possible to modify the technical solutions recorded in the embodiments, or to equivalently replace some or all of the technical features; the modifications or replacements do not cause the essence of the corresponding technical solutions to deviate from the scope of the technical solutions of the embodiments.

What is claimed is:

1. A game effect providing method, suitable for an electronic device comprising an effect providing device, wherein the method comprises:
executing a game application, and capturing a game frame of the game application;
recognizing frame content of the game frame to obtain game status information;
comparing the game status information with at least one threshold value; and
controlling the effect providing device to provide a tactile effect or a visual effect based on a comparison result of the game status information and the at least one threshold value.

2. The game effect providing method according to claim 1, wherein a step of recognizing the frame content of the game frame to obtain the game status information comprises:
recognizing numerical information in the game frame by using text recognition; and
obtaining the game status information according to the numerical information.

3. The game effect providing method according to claim 2, wherein the numerical information is a number of occurrences of an event for a game event, and a step of obtaining the game status information according to the numerical information comprises:
calculating a cumulative number of events within a statistical period based on the number of occurrences of the event.

4. The game effect providing method according to claim 3, wherein the game event comprises a kill event, and the number of occurrences of the event comprises a number of kills.

5. The game effect providing method according to claim 1, wherein the at least one threshold value comprises a first threshold value, and a step of controlling the effect providing device to provide the tactile effect or the visual effect based on the comparison result of the game status information and the at least one threshold value comprises:
when the game status information is less than or equal to the first threshold value, controlling the effect providing device to provide a first tactile effect or a first visual effect; and
when the game status information is greater than the first threshold value, controlling the effect providing device to provide a second tactile effect or a second visual effect.

6. The game effect providing method according to claim 5, wherein the at least one threshold value comprises a second threshold value greater than the first threshold value, and a step of, when the game status information is greater than the first threshold value, controlling the effect providing device to provide the second tactile effect or the second visual effect comprises:
when the game status information is greater than the first threshold value and less than or equal to the second threshold value, controlling the effect providing device to provide the second tactile effect or the second visual effect; and
when the game status information is greater than the second threshold value, controlling the effect providing device to provide a third tactile effect or a third visual effect.

7. The game effect providing method according to claim 1, wherein the effect providing device comprises a main display screen and a secondary display screen, and a step of controlling the effect providing device to provide the tactile effect or the visual effect based on the comparison result of the game status information and the at least one threshold value comprises:
controlling the main display screen to display a main visual effect at an edge of a program frame of the game application; and
controlling the secondary display screen to display a secondary visual effect.

8. The game effect providing method according to claim 7, wherein the secondary display screen faces away from the main display screen, and the secondary visual effect comprises an animated image or a static image.

9. The game effect providing method according to claim 1, wherein a step of controlling the effect providing device to provide the tactile effect or the visual effect based on the comparison result of the game status information and the at least one threshold value comprises:
determining a vibration amplitude based on the comparison result of the game status information and the at least one threshold value; and
controlling the vibration device to provide a vibration effect according to the vibration amplitude.

10. An electronic device, comprising:
an effect providing device;
a storage device recording a plurality of modules;
a processor coupled to the effect providing device and the storage device, and executing the modules and configured to:
execute a game application, and capture a game frame of the game application;
recognize frame content of the game frame to obtain game status information;
compare the game status information with at least one threshold value; and
control the effect providing device to provide a tactile effect or a visual effect based on a comparison result of the game status information and the at least one threshold value.
